(19) United States
(12) Patent Application Publication
(10) Pub. No.: US 2011/0304772 A1
(43) Pub. Date: Dec. 15, 2011

(54) SCREEN ZOOM FEATURE FOR CABLE SYSTEM SUBSCRIBERS

(76) Inventors: Charles Dasher, Lawrenceville, GA (US); Bob Forsman, Sugar Hill, GA (US)

(21) Appl. No.: 12/815,081

(22) Filed: Jun. 14, 2010

(51) Int. Cl. H04N 9/74

(52) U.S. Cl. 348/581; 348/E09.055

(57) ABSTRACT

A screen zoom service provides the ability for a cable system subscriber to request a service which the cable service provider modifies a video data stream so as to replace a portion of the image with a zoomed image. The system uses a zoom level to indicate the level of magnification, a zoom region that defines which area of the image are to be zoomed, and a zoom region location parameter to indicate where the zoom region is to appear on the modified image. Thus, a user invoking the service can see portions of the unmodified video stream and a portion of it zoomed at the same time. The system provides the modified video stream on an indicated channel, and the set top box is informed as to which channel the modified video stream can be located.

### FIELD OF INVENTION

This invention generally pertains to systems and methods for providing a modified video program to a cable subscriber wherein a portion of the video images displayed to the viewer comprises a zoomed image of the video program.

### BACKGROUND OF THE INVENTION

Television viewers have become more sophisticated in their viewing habits. In the past, viewers were only able to view a broadcast program as it was presented to them. However, providing broadcast television service by transmitting digital video signals has enabled many new features to become available to viewers. These features were either not available previously to viewers, or were not available to the same degree. For example, digital signals readily allow frames of video to be stopped or viewed in slow motion with a high level of detail that was difficult to do using analog signals. Digital video signals can be easily stored, duplicated, and processed to adapt to different viewing sizes, formats, and quality levels. Thus, it is possible to for a cable service provider to offer various features which were previously technically difficult to provide.

One service which is not readily available to viewers in a cable system is the capability to zoom-in on certain parts of the video image. Obviously, zooming-in on a portion of the image means that other portions (the non-zoomed portions) may not be displayed. Thus, it is possible that the viewer may not be able to discern the context of the zoomed-in portion relative to the overall video sequence. There is a well known problem that as the image is increasingly zoomed, and occupies the entire screen display, the viewer can lose the context of what is being shown. Thus, there is a need to provide the capability of zooming-in on a portion of a video program, while still preserving a context to the viewer.

### BRIEF SUMMARY OF THE INVENTION

In one embodiment, a system is defined for providing a viewer in a cable system with a modified video stream, where the video stream includes both a zoomed portion of a video image and a non-zoomed portion of the image. In certain embodiments, the viewer is able to indicate parameters associated with the portion of the video that should be magnified, the extent that it should magnified, and where the magnified portion should be positioned relative to the image displayed to the viewer.

In one embodiment, the user can invoke the screen zoom service by manipulating a remote control. The set top box can be instructed to tune to another channel, on which the modified video stream is transmitted by the cable service provider.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a reference image displayed to a viewer on a television,

FIG. 2 illustrates the concept of a zoom region,

FIG. 3 illustrates one embodiment of the zoomed image in the zoom region,

FIG. 4 illustrates another embodiment of the zoomed image in the zoom region,

FIG. 5a illustrates one embodiment of a system providing the screen zoom feature,

FIG. 5b illustrates another embodiment of a system providing the screen zoom feature,

FIG. 6 illustrates one embodiment of the process for a viewer setting up the screen zoom feature,

FIG. 7a-c illustrate one embodiment a user interface for setting up the screen zoom feature,

FIG. 8 illustrates one embodiment of the process for providing the screen zoom feature,

FIG. 9 illustrates one embodiment of the screen zoom manager, and

FIG. 10 illustrates one embodiment of the screen zoom processing steps.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including, but not limited to: technology based on hard disks, CD-ROMs, optical storage devices, solid state storage or magnetic storage devices.

The embodiments are described below with reference to block diagrams and flowchart illustrations of methods performed using computer hardware, apparatus, systems, and computer-readable program products. It should be understood that the block diagrams and flowchart illustrations, respectively, may be implemented in part by a processor executing computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Overview

The service herein is referred to as “screen zoom” for reference purposes. In general terms, the service is a service provided by a cable service provider that typically involves providing a zooming related capability to a viewer of a video program, wherein a portion of video program is presented in a zoomed depiction. The reference to “zoom” typically means to display a portion of the video image at higher magnification, but can apply to a lower magnification. The “zoomed video” or “screen zoomed” video refers to the video as processed by the screen zoom service to alter the relative scale of the image. The alteration or modification of the scale can be positive (magnification) or negative (reduction). Thus, although the invention refers to a “zoom” or “magnifying” a region of an image, this operation can refer to any type of change in the relative scale of the image, and is not limited to only magnifying or zooming the image. In other embodiments, a portion of the video stream is reduced, instead of zoomed.

In various embodiments, the viewer is a subscriber of a cable system, although the invention is not limited only to cable systems, or cable system technologies. The invention is disclosed herein in terms of a cable service provider (“CSP”) for convenience and to illustrate the principles of the invention. The scope of the invention is not limited to such unless otherwise limited by the claim terms. Specifically, the invention can be applied to satellite video service providers, wireless service providers and other service providers using a variety of technologies. Further, the invention can be provided by various types and combinations of components. In some embodiments, these components are located in the service provider's network. However, in other embodiments, the components may be located in equipment local to the viewer.

The operation of the service can be illustrated by showing the result of the video presented to the viewer as a result of invoking the screen zoom feature. The following images are intended to represent one frame of a video sequence. For purposes of illustration, a video image pertaining to a seashell is shown, which is relatively simple in its composition. Although this does not suggest any motion of the object, the principles of the present invention apply to video wherein the objects depicted typically are in motion. The use of “image” herein is not intended to exclude video, but only refer to a particular snapshot of a series of video images.

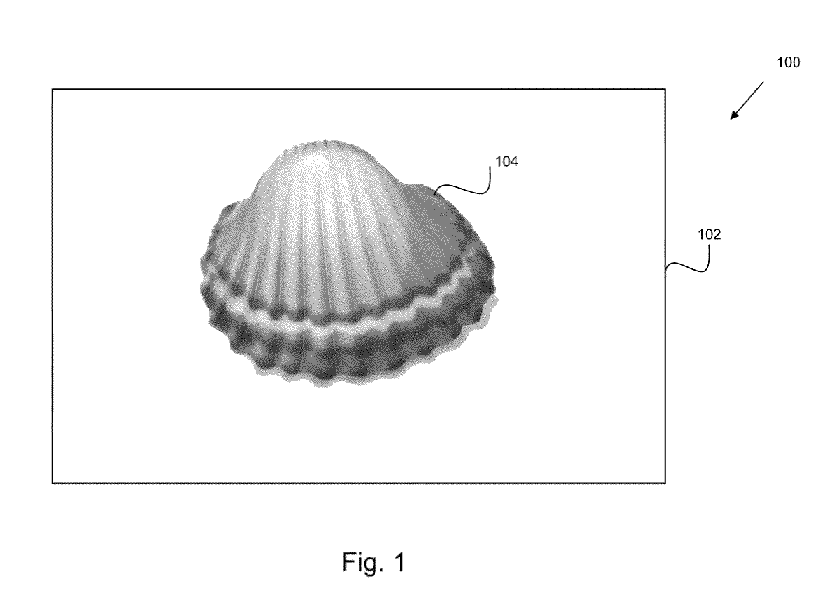

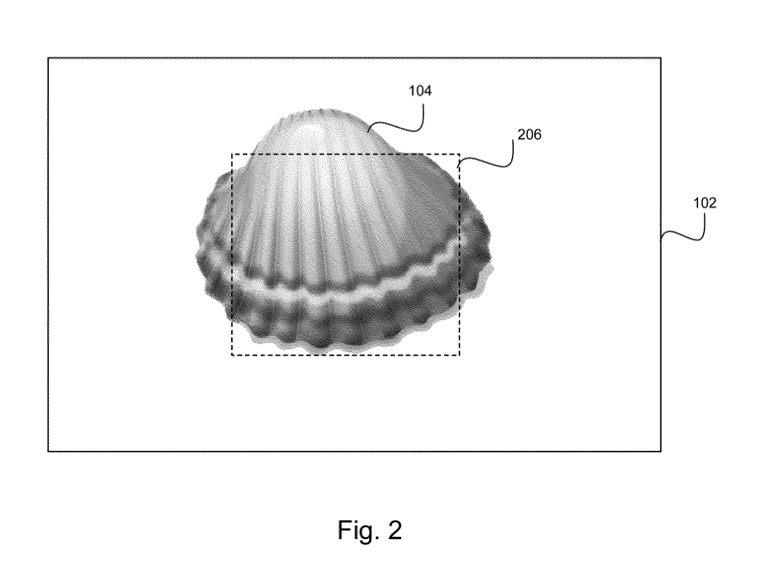

Image 100 of FIG. 1 illustrates the output screen space 102 of a display device, typically which is a television. The square box 102 represents the border of the screen of the television, and the other housings are not shown, nor required to illustrate the invention. Other embodiments may use display monitors coupled with a tuner, but this does not alter the operation of the service. Within the television screen 102 is displayed a seashell (or, simply “shell”). The shell 104 is shown as centered in the screen for illustration purposes.

FIG. 2 illustrates the concept of the “zoom region” 206. In one embodiment, a border representing the zoom region is actually displayed on the screen 102 at one phase of the screen zoom service—namely, when the service parameters are indicated by a viewer. In certain embodiments, the establishment of the service parameters may be defined by the service in a fixed manner (e.g., un-alterable by the viewer), or the parameters may be alterable. In the latter case, a separate process for interacting with the viewer may be used to establish these parameters.

For purposes of illustration, it is assumed that the zoom region 206 is defined as conceptually illustrated in FIG. 2 has been established in some manner. During normal operation of the service (e.g., when the service is presenting the video image with a magnified portion), the dotted line would not be presented to the viewer. The screen zoom region represents that region of the display image which will be zoomed.

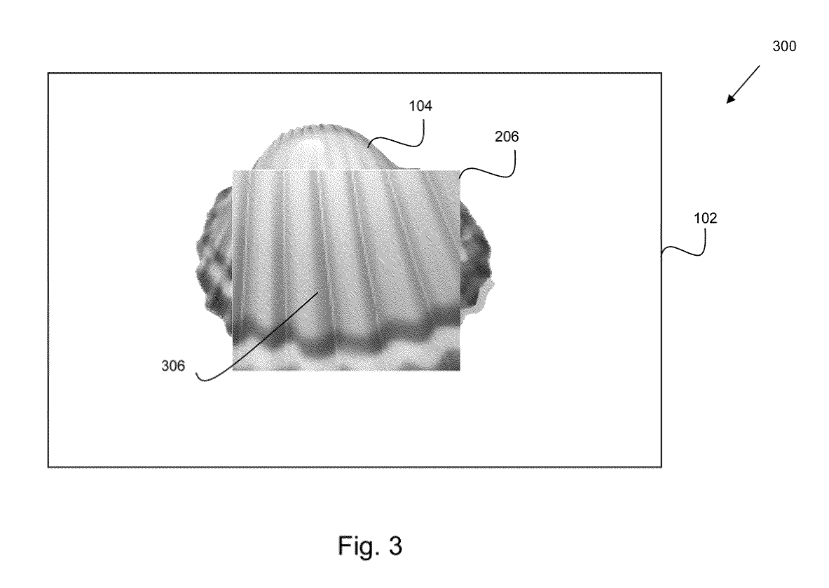

One embodiment of the screen zoomed image is shown in FIG. 3. The resultant image 300 shows that portions of the non-zoomed image 104 are presented as they would normally be presented. However, the zoom region 206 now displays a zoomed image 306. The zoomed image in this embodiment depicts that portion of the image that would normally otherwise be presented. In this embodiment, the center of the zoomed image 306 coincides with the center of the non-zoomed image within the same space. The non-zoomed image is the “normal” image that would normally be presented to the viewer in its unmodified form. Thus, reference will be made to the “zoomed region” and the “non-zoomed region” of the video images presented to the viewer. Thus, it is evident that there are portions of the original (or non-zoomed) image which are not presented in the display 102—either in the non-zoomed region or the zoomed region.

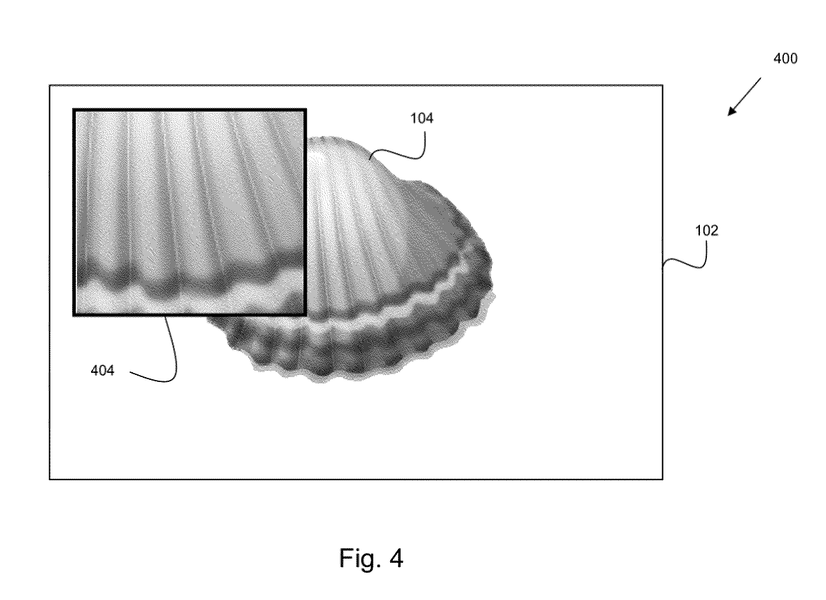

In various embodiments, the size of the zoom region 206 can be altered to be different. sizes. Further, the zoom region 206 can be positioned at different locations of the display screen. One embodiment of a different location is illustrated in the image 400 of FIG. 4. In FIG. 4, the zoom region 404 previously established has been relocated or positioned at the upper left quadrant of the overall screen area 102. In this embodiment, it is observed that there are portions of the image which are duplicated both in the zoom region 206 as well as in the non-zoomed region. Whether this occurs, and to what extend depends on the size of the zoom region, its placement, and also (as it will be seen) the magnification of the zoom.

In other embodiments, the zoom region 206 may actually depict an “inverse zoomed” or panned version of the video. For purposes of illustration, the zoom region typically illustrated video that is zoomed, but in other embodiments, it could be a panned image. Thus, in other embodiments, the region 206 may present the normal video images, and the remainder of the screen display would present the zoom region. However, for purposes of illustrating the principles of the invention, the embodiment is used wherein the zoom region is expands the video image.

In this embodiment the zoom region 404 of FIG. 4 is intended to be depicted as the same size as the zoom region 206 of FIG. 4. Note that the contents of the zoom region in FIG. 3 and FIG. 4 are the same. This is because both are based on the zoom region as defined in FIG. 2.

Thus, it can be seen that the service provides video to the user, wherein a portion of the image comprises a zoom region. The zoom region can be of different sizes and located at different locations of the display area. The zoom region displays a portion of the original image in a zoomed depiction.

There are several applications for the screen zoom service. In one embodiment, a visually impaired viewer can select a portion of the screen, which is zoomed in for viewing. For example, a visually impaired viewer watching a newscast may select the middle of the video to be zoomed. This would allow greater magnification of the face of the newscaster. The position of the zoom region could be located in the middle of the screen (similar to FIG. 3), and enlarged, so that only the face or head view of the newscaster is presented. Relative to FIG. 3, other embodiments may have a larger zoom region. It is possible that the region could be enlarged so as to take up the entire display area 102.

In another embodiment, the video viewed could be a sporting event broadcast. Specifically, for example, a baseball game. In many broadcasts of a baseball game, a common camera perspective is showing the baseball field from behind home plate, so that the entire field occupies the screen. The viewer may select the zoom area as that portion of the screen where the batter is usually featured (e.g., lower center region). The zoom region could be located in the same area, so that the viewer will see the original (e.g., non-zoomed) video of the entire baseball field on the television screen, but the area where the batter is located will be zoomed. This allows the viewer to see both a close up of the batter and a panned view of the field.

As discussed above, the video presented in the zoom region is a portion of the same video that is otherwise presented. In other words, a single video stream of data is processed and modified for presentation to the viewer. Thus, the unmodified (or “original”) video stream has a portion magnified, and then merged back into the video stream to create the modified (screen zoomed) video stream.

### Network Architecture

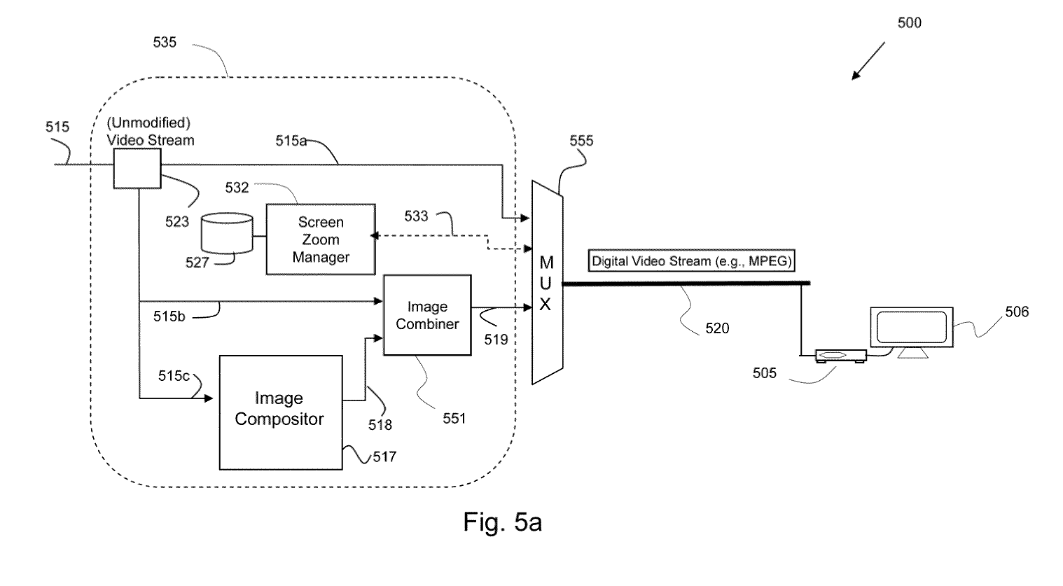

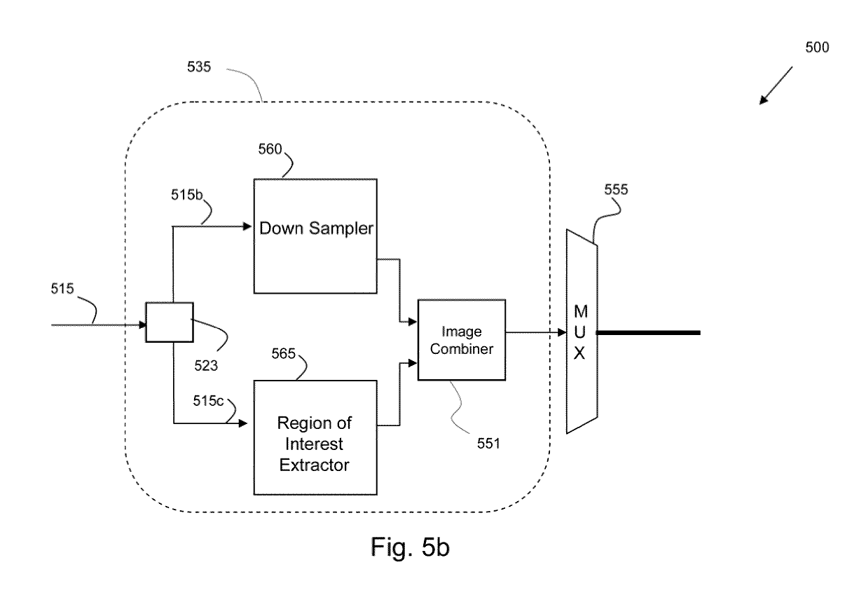

One embodiment for providing this service by a cable service provider is illustrated in FIG. 5a. Although the architecture is illustrated using a cable service provider, this architecture could be adapted and utilized by other types of service providers. Many cable service providers transmit HDTV based digital video streams in an MPEG format, and hence this example will be used to illustrate the principles of the present invention. However, the video signals can be transmitted using other encoding schemes, including but not limited to H.264, Ogg encoding, wavelet based encoding schemes, etc. Further, the streamed video data does not have to necessarily be in an MPEG-2 compatible format. Even within the MPEG-2 standard, there are different profiles and levels of encoding, and it is envisioned that various encoding levels will be accommodated, and the zoomed region and the non-zoomed region of video data presented to the viewer may reflect different encoding levels of the video data.

The screen zoom system 535 can be explained by first describing how the viewer receives an unmodified video signal at their television set. Assume that an unmodified video signal 515, which may be a broadcast video signal, is received by the cable service provider (“CSP”) in a conventional manner, e.g., including satellite delivery, optical fiber transmission, etc. The signal may be transcoded (not shown), but the contents of the signal is provided as an unmodified signal 515a to the multiplexing equipment 555, which grooms a number of digital video signals (not shown) onto the cable distribution network 520. From there, the digital videos signals are transported over the distribution network, which can be based on various technologies. In various embodiments, this can be based on wireless, twisted pair, coaxial, fiber optic, or other types of technologies.

The viewer's location is illustrated in this embodiment as including a set top box 505 and a television set 506, which receives, decodes, and displays images of the unmodified video stream. The aspect of providing a digital video signal, such as a broadcast television program, over a cable network is well known in the art. This may be the architecture used to provide the unmodified (non screen zoomed signal) to the viewer.

In order to provide the screen zoom video stream (“modified” video stream), the video stream 515 is duplicated by duplicator 523 to form two separate video streams 515b, 515c. For purposes of illustration, the signals 515b, 515c are the same unmodified image. These are provided to an image combiner 551 and an image compositor 517 respectively. Although these are illustrated as two separate functions, these functions could be implemented as a single function, in a single component, which receives a single input.

The image compositor function processes the digital video data by composing the image data as desired. Typically, the image data is processed so that it is presented as being zoomed in the otherwise unprocessed (“normal”) video stream to create a magnified image. In some embodiments, magnification may require interpolation of pixels using an algorithm, or merely duplication of existing pixels in an area. In some embodiments, the video stream may have sufficient image density so as to allow presentation of a magnified image without loss of image data. For example, the video stream 515 provided to the system may be a very high quality encoded video stream, such as 4000×2250 pixel of video information per video frame. However, the cable system may typically provide a lower resolution, such as 1920×1080. Thus, the “magnification” that occurs in the zoom region is actually a portion of the 4000×2250 video encoding, which can be processed to provide the image to the viewer. In other embodiments, the “normal” video provided to viewers is a “downsampled” version of the higher resolution encoding. Thus, the same effect can be accomplished by either magnifying a portion of a video and presenting it to the viewer in the zoom region, or presenting an unmodified portion of the video in the zoom region and downsampling the other portion of the video that is normally presented to the viewer. Those skilled in the art will recognize that various algorithms can be used to create the effect of zooming the image data in the zoom region.

To summarize, in one embodiment, the input to the image compositor 517 is the unmodified or unzoomed video data, and the output of the image compositor 517 is typically the magnified image data. (In other embodiments, it could be panned images.) In one embodiment, the image compositor 517 only processes a portion of the image data for magnification. Specifically, the image compositor may only zoom in on the area corresponding to the zoom region 206. In other embodiments, the image expanded may magnify the entire frame and then crop the magnified image data to the size of the zoom region. In the former case, unnecessary processing can be avoided. Thus, the output of the image compositor 517 in this embodiment is the zoom region magnified to the appropriate level.

The image compositor typically will access, store, or will be provided with, parameters defining the zoom level and the zoom region. These parameters may be defined for each viewer as a settable parameter, or default values may be used. FIG. 5a depicts operation presuming that the system is aware of the appropriate parameters to use, and illustrates the main operation of modifying the streaming video. FIG. 5a by itself does not limit how the system obtains the parameters used in processing the video stream.

The image combiner 551 receives the expanded image output 518 and the original (unmodified) streaming video 515b. The image combined 551 combines or merges the two video data stream to provide a single output stream 519 that is then multiplexed through the multiplexor 555. From there, it goes on to the other components of the headend, onto the user's premises. The operation of the image combiner 551 involves taking the expanded image, which may have been sized to the zoom field) and process that pixel content to replace the corresponding zoom field (and in its appropriate location) of the unmodified streaming video. The resulting streaming video then comprises the screen zoom video. At this point, the resulting streaming video is transported similar to other MPEG video streams.

Another embodiment of the network architecture is shown in FIG. 5b. This figure depicts an alternative embodiment of the image compositor and the image combiner, and does not depict the customer premises equipment, screen zoom manager, 532, etc.

In FIG. 5b, the video input 515 is provided from a video source to a duplicator 523, which provides a copy of the signals to the Down Sampler 560, and the Region of Interest Extractor 565. The video input signal 515 in this embodiment is a very high quality video signals, which in its native form, is not transmitted over the cable distribution network, because the bandwidth consumed may be too great for the cable distribution network's resources. The Down Sampler 560 may process the video so that a lower quality image is produced, which can still be, relatively speaking, a high quality HDTV based MPEG signal image. Simultaneously, the Region of Interest Extractor 565 determines the region from which to extract the video signals. This area corresponds to the zoom region, but because the region is not zoomed, it is not called the zoom region. This area of the video retains it native encoding level in this embodiment, and it is the rest of the video image that is downsampled. The two video streams are then provided to the image combiner that merges the images, similar to as discussed previously.

The above processes explains how the unmodified video stream is duplicated, processed, and merged back with the original video stream to create the screen zoom video stream. In different embodiments, one portion of the video stream may be processed to provide a greater resolution image than what is presented normally to the video to the viewer, whereas in other embodiments, the portion of the video stream is retained at the original encoding level, and the video streamed is processed to provide a lower resolution. Thus, in either approach, there is a first portion that appears to the viewer as a magnified image relative to the normally provided video image, However, this presumes that the various parameters defining the zoom level, zoom region, and zoom region placement are known to the system 535. Further, this presumes that the set top box is aware of how to tune and receive the screen zoom video. These capabilities involve the screen zoom manager 532. These two aspects are discussed below.

### Screen Zoom Parameter Determination

The screen zoom system uses parameters to indicate the level of magnification (screen zoom level), the area which is to be magnified (zoom region), and the placement of the zoom region with respect to the original streaming video (zoom region placement).

In one embodiment, these values can be fixed by the service provider, and thus programmed into the system in various ways. Alternatively, the values can be established when the service is provisioned, using similar means for establishing other service parameters as for other services. In one embodiment, these service-related parameters are stored in a data store 527 which is accessed by the screen zoom manager 532 as required.

In another embodiment, the viewer can select from a limited set of options, using an application downloaded to the set top box. In this embodiment, the set top box provides a set of menu options for allowing the user to select one from a limited set for each of the parameters. After selection, the set top box then communicates the parameter to the screen zoom system 535, specifically to the screen zoom manager 532. The screen zoom manager comprises a programmable computer executing instructions for performing the steps indicated herein.

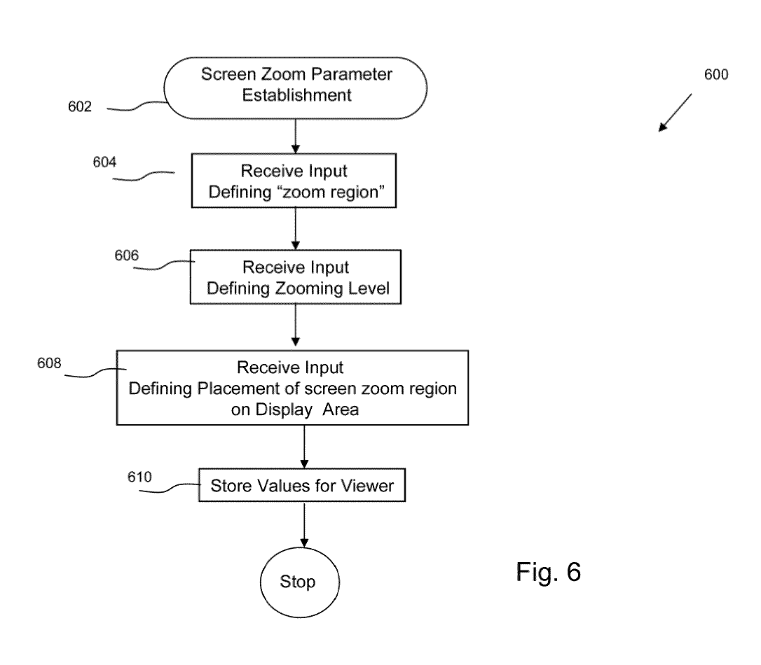

This process 600 is illustrated in FIG. 6, where the screen zoom parameter establishment 602 process begins with the screen zoom manager 532 receiving input 604 from the user defining the “zoom region” (a.k.a. “screen zoom region”). Next, the screen zoom manager 532 receives input 606 from the user defining the zoom level to be applied. Finally, the screen zoom manager 532 may receive input 608 from the user indicating where placement of the zoomed region should be positioned. The screen zoom manager 532 then stores the values at step 610, and the screen zoom service can then be invoked for a that viewer.

The user can invoke the parameter set up by indicating a function key on the remote control which triggers a screen zoom parameter establishment process. In another embodiment, the process can be defined as a sub-menu of another feature, already in the set top box. In this case, the screen zoom parameter establishment process may simply be a sub-menu selection of another service.

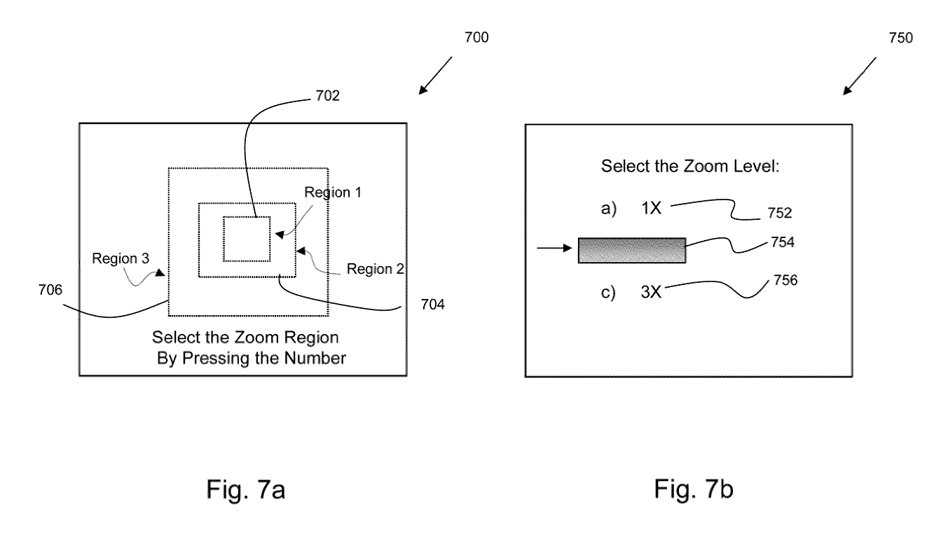

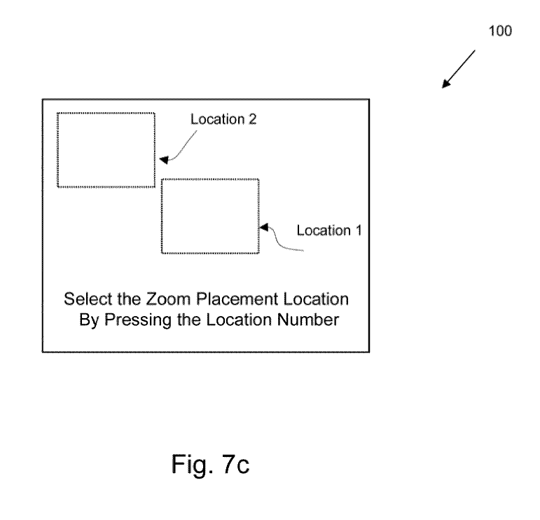

FIG. 7a illustrates one embodiment wherein a viewer is prompted by an interactive menu screen. These screen images are generated by the screen zoom manager 532 interacting with the set top box image generator capabilities and result in a display image presented to the user. In FIG. 7a, the menu presents three zoom regions to the viewer. Region 1 702 is the smallest, followed by Region 2 704, and Region 3 706 which is the largest. In one embodiment, the user can select one of the zoom regions using the remote control, with each selection highlighted. In other embodiments, the user can enter a number corresponding to the screen zoom size. In other embodiments, the user could be prompted with a number which the system then maps to a screen size (e.g., such as a percentage value of the maximum possible size). In other embodiments, a grid can be overlaid on the screen forming squares on the display (e.g., 5×5 or 25 squares). The user can then select one or more areas using the remote controller to indicate which areas comprise the zoom region. In one embodiment, the user can combine the functions of indicating the size of the region and its location relative to the screen in a combined manner.

FIG. 7b illustrates a menu interface for the viewer selecting a magnification (zoom) level. This may be illustrated as “X” factor (e.g., 2X is 200%), or can be indicated as a percentage. Other embodiments may allow the user to enter a number, but in this embodiment, the user is allowed to select one of three options.

FIG. 7c illustrates one embodiment for a menu interface allowing the user to select a location of the screen zoom. In this embodiment, it is presumed the user selected Region 2, which corresponds to the size shown in FIG. 7c. The user in this embodiment is limited to selection of two locations: center or upper left corner. Other embodiments may provide more choices, or may simply allow only a fixed location. Those skilled in the art will recognize that various alternatives for obtaining these parameters are possible. For example, the user may be able to select some of the parameters, and have others fixed by the system.

### Screen Zoom Service Invocation

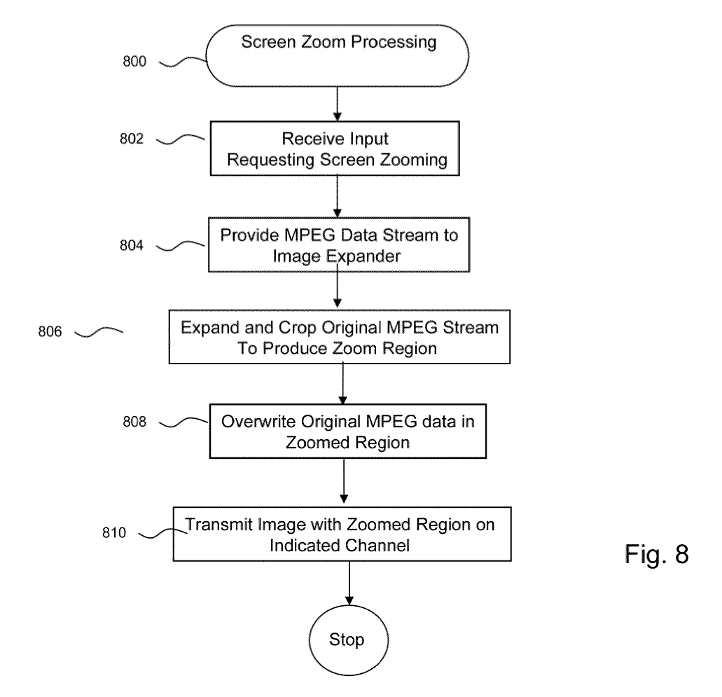

The process 800 for invoking the service is illustrated in FIG. 8. In this figure, the user is presumed to have previously established the various screen zoom parameters, which are used when processing the video stream. In this embodiment, prior to invoking the service, the user is also presumed to be viewing the program for which screen zooming is to be applied. Thus, the target video has been selected for viewing. At step 802, the viewer provides input indicating the screen zoom service is desired. In one embodiment, the request for service is indicated by pressing a function key on the remote control. This indicates to the set top box to execute an application which communicates to the cable headend the request for the screen zoom service. The set top box may also include an identifier, such that the screen zoom system is able to identify the viewer, and retrieve the viewer's parameters for the service.

The headend receives the service request, which is passed to the screen zoom system 535 of FIG. 5a. Specifically, in this embodiment, the request is passed to the screen zoom manager 532, which is augmented to processes screen zoom requests and manages the workflow with other components to provide the screen zoom service. Other embodiments may utilize a processor that is used for other services, or may even augment an existing service to provide the screen zoom capability.

The channel the viewer is presently tuned to and viewing remains unchanged as it is broadcasted over the distribution network. The channel may be viewed by other subscribers in the cable system, who may not desire to view the zoomed image. Alternatively, other subscribers may have other screen zoom parameters. Consequently, the screen zoomed video stream is not used to replace the unmodified video stream on the cable distribution network.

The VOD Session Manager upon receiving the request ascertains the viewer initiating the request by using the set top box identifier included in the request. This information can be used to retrieve the viewer's screen zoom parameters. These are provided to the image compositor 517 and the image combiner 551 as necessary by the screen zoom manager 532. The screen zoom manager then instructs the duplicator 523 to provide a copy of the unmodified broadcast video to the image compositor 517 and the image combiner 551. The zoom system is now ready to process the unmodified video stream to generate the modified video stream for the viewer.

In order for the viewer to see the modified video stream, the set top box has to be informed as to which channel the screen zoom system 535 will be streamed on. Thus, the VOD Session Manager instructs the set top box via signaling 533 as to which channel the modified video will be multiplexed on. This information is sent to the set top box, which retunes its tuner. After this is transmitted, the Screen Zoom Manager 532 instructs the image combiner 551 to stream the modified video on a particular channel into the multiplexer 555. The modified video stream is then transmitted to the set top box, where it is tuned to receive the modified video.

The provision of the modified screen zoomed video stream is similar to a so-called “real-time on-demand” or “near video on demand” capability in that a real time streaming image is delayed for a very short time and streamed on another channel to the viewer. In other words, when the viewer requests a screen zoom video, the unmodified video stream is processed by the screen zoom system in real time, and streamed to the viewer. The delay may be very short (less than a second) so that the user may at most observe a slight discontinuity between the broadcast program and the screen zoomed version. The implementation of the screen zoom service may be facilitated in some embodiments by augmenting existing VOD capabilities to incorporate aspects of the screen zoom manager.

The user can request termination of the screen zoom service while viewing a screen zoomed video stream. The termination request can be indicated by pressing the function key on the remote control. The application processing the input in the set top box would then relay this information to the headend, where the screen zoom manager would instruct the set top box to retune back to the original channel. The screen zoom manager would then instruct the other components, such as the image compositor and image combiner, to cease operation. The channel allocated to convey the screen zoomed channel would no longer be needed and would be available for reallocation.

In other embodiments, the invocation of the screen zoom service can be triggered using an extended binary interchange format (“EBIF”) which is a mechanism well known to those skilled in art for invoking services in a set top box in a cable system. An EBIF application can be transmitted with a video program, which when the EBIF application is triggered, presents to the viewer a text box overlaid on the video program. The text box can prompt the viewer to press a selected key on the remote control to invoke screen zoom viewing. When the user presses the appropriate function key, a message is transmitted to the headend, where it is received by a server. The server can process the message and cause the screen zoom system to stream a screen zoomed image on a particular channel. At the same time, the application in the set top box, when executed, will instruct the set top box to tune to that particular channel. The set top box will then tune to, and receive, the screen zoom channel. The screen zoomed channel is streamed in near real time relative to the unmodified video stream. In this manner, if only a single set of screen zoom parameters are defined, multiple viewers in a cable system can potentially simultaneously view a screen zoomed modification of a presently stream video program.

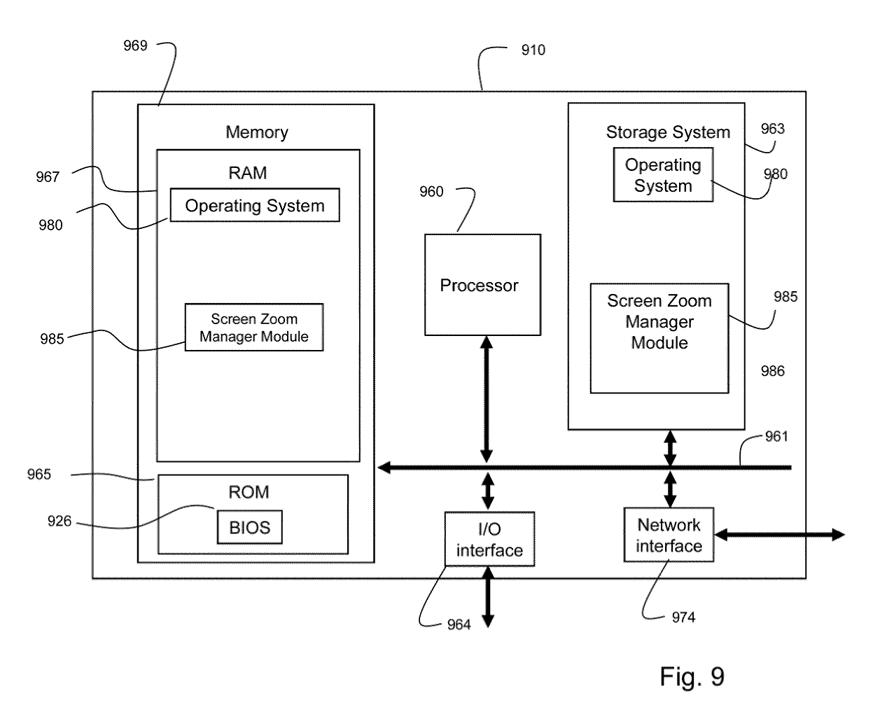

FIG. 9 illustrates one embodiment of the system 535. The system 535 may comprise a single processor which performs the functions identified for the screen zoom manager, the image combiner, and the image compositor. In other embodiments, separate processing structures may be used for the screen zoom manager, and another processing component used for the combination of the image combiner and the image compositor. Various other combinations of general purpose computers, or specialize processors can be used.

In this embodiment, a processor 960 is shown as communicating over a data bus 961 to memory modules 969 and data storage system 963. The memory comprises RAM 967 and ROM 965. The RAM memory stores the screen zoom manager module 985 and the operating system 980, and the ROM stores BIOS code 926. The operating system 980 and screen zoom module 985 may also be stored in the storage system 963. The system also comprises an I/O interface 964, which can receive and transmit the digital video signals, and the network interface 974 can be used to communicate with other components (if multiple components are used to implement the system).

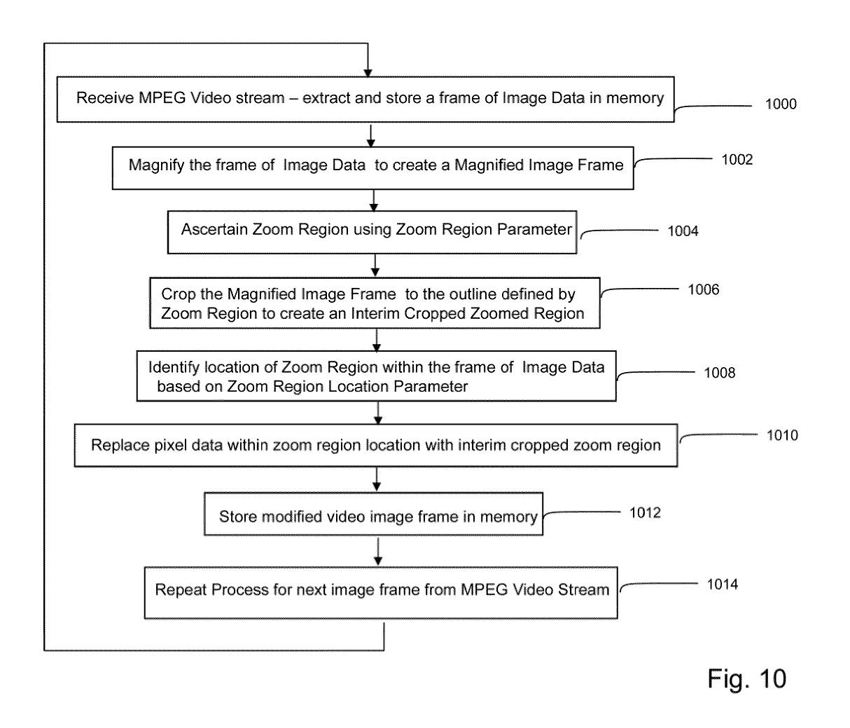

The processor executes the screen zoom manager module 985, which comprises the instructions for allowing establishment of the parameters and controlling the components for service invocation, as well as processing of the modified image data. One embodiment of the steps for generating the modified image data is shown in FIG. 10.

In FIG. 10, the process begins with step 1000 which receives a frame of video data, which is extracted from one or more MPEG frames in order to generate a frame of Image Data. This is stored in memory, as it will be manipulated subsequently. In step 1002, this frame of data is magnified or zoomed, using a number of well known algorithms. The resulting image is called the Magnified Image Frame, which is also stored in memory. In the next step 1004, the zoom region is determined. This may be a default value, or a value associated with each viewer. Once obtained, it is usually stored in memory, so that it is readily available for processing. In step 1006, the zoom region is used to crop the magnified image to extract the appropriate area. This cropped image data is called the Interim Cropped Zoomed Region. Note that in other embodiments, the Image Data may be cropped first, and then magnified. This embodiment uses less processing cycles.

Next, the location of where the zoom region is to be placed on the Image data is identified in step 1008. This indicates the placement of the zoom data. In Step 1010, this pixel data in the zoom region location is replaced using the Interim Cropped Zoomed Region. This “inserts” the zoomed data in the proper location of the image data (see, e.g., FIG. 4). For example, if the placement of the zoom region is in the upper left corner, the appropriate pixels in the original frame corresponding to this area will be replaced with the interim zoom data. The modified image frame is stored in memory 10102, and the process is repeated in step 1014. Once a sufficient number of modified image frames are stored in memory, then a sequence of MPEG frames can then be generated.

In other embodiments, the screen zoom manager may coordinate other signal processing devices which are dedicated to processing the MPEG pixel data in order to expand (zoom) the zoom region and then merge (combine) it with the unmodified image data.

1. A method for providing a modified video data stream for display to a viewer on cable system comprising the steps of:
receiving a request at a processor from said viewer comprising a subscriber of a cable service provider, wherein said viewer uses a set top box to request a screen zoom service, said request identifying a video data stream comprising an MPEG based video data stream;
ascertaining by said processor a screen zoom region parameter, a zoom level parameter, and a screen zoom region placement parameter for use in modifying a first image of said video data stream to produce said modified video data stream;
using the screen zoom region parameter by said processor to identify an area of said first image of said video data stream to be magnified;
using the zoom level parameter by said processor to determine a level of magnification of said first image to create a magnified image;
using the screen zoom region placement parameter by said processor to determine a location to place said magnified image in relation to said first image;
indicating by said processor to said set top box a particular channel associated with a cable distribution network to which said set top box should tune to in order to receive said modified video data stream; and
providing said modified video data stream to said viewer by transmitting said video data stream over said channel on said cable distribution network of said cable service provider, wherein said video data stream comprises a screen zoom region comprising said magnified image at said level of magnification, wherein said screen zoom region is positioned at said location.

2. The method of claim 1 wherein the request is conveyed from said set top box of said cable service provider in response to receiving an input transmitted from a remote control unit operating the set top box.

3. The method of claim 1 wherein at least one of said zoom region parameter, said zoom level parameter, and screen zoom region placement parameter are default values stored in a memory accessed by said processor.

4. The method of claim 3 wherein as least one of said zoom region parameter, said zoom level parameter, and screen zoom region placement parameter is selected by the viewer in response to a prompt generated by said processor.

5. The method of claim 1 wherein said screen zoom placement parameter indicates the center of a display area.

6. The method of claim 1 wherein a duplicate video data stream is provided to a screen zoom system processing said MPEG based video data stream wherein an image compositor magnifies said first image to generate an expanded image and an image combiner merges at least a portion of said expanded image to generate said modified video stream.

7. The method of claim 1 further comprising the step of receiving a second request from said viewer wherein said second request comprises a request to terminate said screen zoom service, wherein said processor in response to said second request instructs said set top box to tune to a second particular channel associated with a cable distribution network.

8. The method of claim 7 wherein said second particular channel comprises said MPEG based video data stream.

9. The method of claim 1 wherein said processor is configured to generate said modified video data stream by:
identifying a portion of an image of said MPEG based video data as zoom region data;
processing at least a portion of said zoom region data to magnify said zoom region data thereby producing magnified zoom region data; and
combining at least a portion of said magnified zoom region data with at least a portion of said image of said MPEG based video data stream.

10. A system for generating a modified MPEG video stream, said system comprising:
a first processor configured to:
receive a request from a viewer that is a subscriber of a cable service provider, said request for a screen zoom service wherein the request identifies said video data stream comprising an MPEG based video data stream;
ascertain a screen zoom region parameter, a zoom level parameter, and a screen zoom region placement parameter for use in modifying a first image of said video data stream;
use the screen zoom region parameter to identify an area of said first image of said video data stream to be magnified;
use the zoom level parameter to determine a level of magnification of said first image to create a magnified image;
use the screen zoom region placement parameter to determine a location to place said magnified image in relation to said first image;
indicate a particular channel associated with a cable distribution network to which set top box should tune to in order to receive said video data stream; and
provide said modified video data stream to said viewer by transmitting said video data stream over said channel on said cable distribution network of said cable service provider, wherein said video data stream comprises said screen zoom region comprising said magnified image at said level of magnification, wherein said screen zoom region is positioned at said location.

11. The system of claim 10 wherein said processor is further configured to receive said request conveyed by a set top box over a cable distribution network wherein said request includes a set top box identifier.

12. The system of claim 10 further comprising:
a memory, wherein said memory stores said screen zoom region parameter, said zoom level parameter, and said screen zoom region placement parameter.

13. The system of claim 12 wherein said processor is configured to receive input from a set top box selecting at least one of said screen zoom region parameter, said zoom level parameter, and said screen zoom region placement parameter.

14. The system of claim 10 further comprising:
a second processor configured to process said MPEG based video data stream to create said magnified image.

15. The system of claim 10 further comprising:
a multiplexor located in the cable service provider configured to multiplex simultaneously both said video data stream and said modified video data stream.

16. The system of claim 11 further comprising:
a database storing said screen zoom region parameter, said zoom level parameter, and said screen zoom region placement parameter in associated with said set top box identifier.

17. The system of claim 11 further comprising:
a set top box, wherein said set top box comprises a second processor configured to:
receive a message indicating said particular channel from said first processor; and
tune to said indicated particular channel in response to receiving said message.

18. A computer readable medium comprising instructions for instructing a processor to perform the steps of:
receiving a request for a screen zoom service from a set top box of a subscriber of a cable service provider;
receiving image data from an MPEG based video stream and storing said image data in memory;
processing said image data so as to magnify a portion of said image data corresponding to an area defined by a zoom region thereby creating magnified image data;
determining a location of placing said magnified image data in said image data;
combining said magnified image data into said image data at said location thereby generating a modified image data;
generating a modified MPEG based video stream using said modified image data;
transmitting said modified MPEG based video stream on a channel previously indicated to said set top box associated with said subscriber.

19. The computer readable medium of claim 18 further comprising the step of cropping said magnified image data to correspond to said zoom region.

20. The computer readable medium of claim 18 further comprising the step of using a set top box identifier of said subscriber to retrieve said screen zoom region parameter, said zoom level parameter, and said screen zoom region placement parameter for a database.
